(19) United States
(12) Patent Application Publication
(10) Pub. No.: US 2019/0034012 A1
(43) Pub. Date: Jan. 31, 2019

(54) TOUCH SUBSTRATE, MANUFACTURING METHOD THEREOF AND TOUCH DEVICE

(71) Applicants: BOE TECHNOLOGY GROUP CO., LTD., Beijing (CN); Hefei insheng Optoelectronics Technology Co., Ltd., Hefei, Anhui (CN)

(72) Inventors: Xiaodong XIE, Beijing (CN); Ming HU, Beijing (CN); Ming ZHANG, Beijing (CN); Jing WANG, Beijing (CN); Yu ZHU, Beijing (CN); Yulei WANG, Beijing (CN)

(21) Appl. No.: 15/752,643

(22) PCT Filed: Jul. 24, 2017
(86) PCT No.: PCT/CN17/94035

§ 371 Date: Feb. 14, 2018

(30) Foreign Application Priority Data
Aug. 31, 2016 (CN) 201610791932.1

(51) Int. Cl. G06F 3/041

(52) U.S. Cl. CPC G06F 3/0412; G06F 2203/04103

(57) ABSTRACT

A touch substrate includes: a plurality of first touch electrodes and a plurality of second touch electrodes provided on a base substrate within a touch region and being intersected each other laterally and longitudinally; a plurality of first binding patterns and a plurality of second binding patterns provided at a side of the touch region; and first signal lines connecting the first touch electrodes to the first binding patterns, and second signal lines connecting the second touch electrodes to the second binding patterns, wherein the first signal lines and the second signal lines are provided in different layers, and a projection of a region in which the first signal lines are located on the base substrate and a projection of a region in which the second signal lines are located on the base substrate have partially overlapped regions.

### CROSS REFERENCE

The present application is based upon International Application No. PCT/CN2017/094035, filed on Jul. 24, 2017, which claims the priority of Chinese Patent Application No. 201610791932.1, filed on Aug. 31, 2016, and the entire contents thereof are incorporated herein by reference as part of the present application.

### TECHNICAL FIELD

The present disclosure relates to the field of touch technology, and in particular, to a touch substrate, a manufacturing method thereof and a touch device.

### BACKGROUND

Touch panels achieve simple and flexible human-computer interaction by calculating coordinates of touch points within a touch region and information processing etc. With the development of electronic products, the demand for visual effect of touch display devices is on the rise, and narrow frame design is becoming more and more popular.

It should be noted that, information disclosed in the above background portion is provided only for better understanding of the background of the present disclosure, and thus it may contain information that does not form the prior art known by those ordinary skilled in the art.

### SUMMARY

The embodiments of the present disclosure provide a touch substrate, a manufacturing method thereof and a touch device.

To achieve the above objective, the embodiments of the present disclosure adopt following technical solutions.

According to one aspect of the embodiments of the present disclosure, there is provided a touch substrate, including: a plurality of first touch electrodes and a plurality of second touch electrodes provided on a base substrate within a touch region and being intersected each other laterally and longitudinally; a plurality of first binding patterns and a plurality of second binding patterns provided at a side of the touch region; and first signal lines connecting the first touch electrodes to the first binding patterns, and second signal lines connecting the second touch electrodes to the second binding patterns, wherein, the first signal lines and the second signal lines are provided in different layers, and a projection of a region in which the first signal lines are located on the base substrate and a projection of a region in which the second signal lines are located on the base substrate have partially overlapped regions.

Further, the partially overlapped regions are located at a side of the touch region at which the first binding patterns and the second binding patterns are provided.

Further, the first touch electrodes are formed in an integrated structure, the second touch electrodes include a row of touch sub electrodes and bridge point patterns connecting adjacent ones of the touch sub electrodes, the touch sub electrodes and the first touch electrodes are provided in a same layer, and the bridge point patterns and the first touch electrodes are provided in different layers.

Further, the second signal lines and the bridge point patterns are provided in a same layer, and the bridge point patterns and the second signal lines are made of metal or transparent conductive material.

Further, the first signal lines and the first touch electrodes are provided in a same layer, or the first signal lines and the first touch electrodes are provided in different layers, and wherein the first signal lines are made of metal.

Further, the first signal lines are lapped to the first touch electrodes at a connecting position.

Further, in a case that the second signal lines and the bridge point patterns are provided in a same layer, the bridge point patterns are made of transparent conductive material, the first signal lines and the first touch electrodes are provided in different layers, and the first signal lines are made of metal, a distance between the bridge point patterns and the base substrate is smaller than a distance between the first touch electrodes and the base substrate.

Further, the first touch electrodes and the second touch electrodes are formed in integrated structures, respectively; the first signal lines and the first touch electrodes are provided in a same layer, the second signal lines and the second touch electrodes are provided in different layers, and the second signal lines are made of metal; or, the second signal lines and the second touch electrodes are provided in a same layer, the first signal lines and the first touch electrodes are provided in different layers, and the first signal lines are made of metal.

Further, in a case that the second signal lines are made of metal and the first signal lines are made of transparent conductive material, a distance between the second signal lines and the base substrate is greater than a distance between the first signal lines and the base substrate.

Further, the first signal lines are made of metal, the second signal lines are made of transparent conductive material, and a distance between the first signal lines and the base substrate is greater than a distance between the second signal lines and the base substrate.

According to another aspect of the embodiments of the present disclosure, there is provided a touch device, including any one of the touch substrates above.

Further, the touch device includes a display panel, the touch substrate and the display panel are formed in an integrated structure, the touch substrate is located inside or outside the display panel, and the display panel and the touch substrate share a same base substrate; or, the touch substrate and the display panel are two separate structures, and the touch substrate is located outside the display panel.

According to still another aspect of the embodiments of the present disclosure, there is provided a manufacturing method of touch substrate, including: forming a first conductive layer on a base substrate, and forming bridge point patterns and second signal lines by a patterning process; forming an insulating layer on the base substrate on which the bridge point patterns and the second signal lines are provided, and forming insulating patterns by a patterning process; forming first touch electrodes and touch sub electrodes on the base substrate on which the insulating patterns are formed, wherein, the adjacent touch sub electrodes in a row of the touch sub electrodes are connected to each other through the bridge point pattern and form a second touch electrode, and the second touch electrode is connected to the second signal line; forming first signal lines, first binding patterns and second binding patterns made of metal on the base substrate on which the first touch electrodes are formed, wherein, one end of the first signal line is connected to the first touch electrode, the other end of the first signal line is connected to the first binding pattern, the second binding pattern is connected to an end of the second signal line to which the second touch electrode is not connected, and a projection of a region in which first signal lines are located on the base substrate and a projection of a region in which second signal lines are located on the base substrate have partially overlapped regions.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

In order to more clearly illustrate the technical solutions in the embodiments of the present disclosure or in the prior art, drawings used to describe the embodiments or the prior art will be briefly described below. It will be apparent that the drawings in the following description refer only to some embodiments of the present disclosure, and other drawings are available to those of ordinal skill in the art based on these drawings without creative work.

FIG. 1 is a structural schematic diagram of a touch substrate according to a comparison example;

FIG. 2 is a structural schematic diagram of a touch substrate provided by embodiments of the present disclosure;

FIG. 3 is a structural schematic diagram of another touch substrate provided by embodiments of the present disclosure;

FIG. 4 is a structural schematic diagram of still another touch substrate provided by embodiments of the present disclosure;

FIG. 5 is a structural schematic diagram of a touch device including a touch substrate provided by embodiments of the present disclosure;

FIG. 6 is a structural schematic diagram of another touch device including a touch substrate provided by embodiments of the present disclosure;

FIG. 7 is a structural schematic diagram of still another touch device including a touch substrate provided by embodiments of the present disclosure;

FIG. 8 is a flow chart of a manufacturing method of a touch substrate provided by embodiments of the present disclosure;

FIG. 9a is one of structural schematic diagrams for manufacturing a touch substrate provided by embodiments of the present disclosure;

FIG. 9b is one of structural schematic diagrams for manufacturing a touch substrate provided by embodiments of the present disclosure;

FIG. 9c is one of structural schematic diagrams for manufacturing a touch substrate provided by embodiments of the present disclosure;

FIG. 9d is one of structural schematic diagrams for manufacturing a touch substrate provided by embodiments of the present disclosure; and

FIG. 10 is an interlayer structural schematic diagram for manufacturing a touch substrate provided by embodiments of the present disclosure.

### REFERENCE NUMERALS

01-lateral touch electrode; 02-longitudinal touch electrode; 03-signal line; 10-touch substrate; 101-first touch electrode; 1011-first binding pattern; 110-light shielding layer; 102-second touch electrode; 1020-touch sub electrode; 1021-second binding pattern; 1022-bridge point pattern; 1023-insulating pattern; 1024-protective layer; 11-first signal line; 12-second signal line; 20-display panel; 201-base substrate; A-touch region; B-partially overlapped region.

### DETAILED DESCRIPTION

Hereinafter, the technical solutions of the embodiments of the present disclosure will be described clearly and completely in conjunction with the accompanying drawings of the embodiments of the present disclosure. It is obvious that the described embodiments are only part of the embodiments rather than all embodiments of the present disclosure. All other embodiments obtained by one of ordinary skill in the art based on the described embodiments of the present disclosure without creative work are within the protection scope of the present disclosure.

Orientation terms, such as “on”, “under” and the like, are defined herein with respect to the orientation of the touch substrate schematically placed in the drawings. It should be understood that these orientation terms are relative concepts and used to describe and clarify the relativity, and these orientation terms can be changed correspondingly according to the change of the orientation where the touch substrate is placed.

In addition, in the present disclosure, a patterning process may include a photolithographic process, or, may include a photolithographic process and an etching step. Meanwhile, the patterning process may further include other processes for forming predetermined patterns, such as a printing process, an inkjet process and the like. The photolithographic process refers to a process for forming a pattern using photoresists, masks, an exposure machine and the like, including processes of film formation, exposing, developing, etc. The corresponding patterning process may be selected according to the structure formed in the present disclosure.

FIG. 1 is a structural schematic diagram of a touch substrate according to a comparison example. As illustrated in FIG. 1, a touch panel includes touch electrodes provided intersecting each other laterally and longitudinally. The lateral touch electrode 01 and the longitudinal touch electrode 02 are both connected to signal lines at an edge region, and all of the signal lines 03 are located in the same layer and formed by one time of a manufacturing process. Due to the constraint of manufacturing process, the width of the signal line 03 cannot be further reduced. Thereby, the width of the wiring region is the sum of the widths of the wiring regions of the above two signal lines. That is, the whole wiring region has a larger width, which is disadvantageous to the narrow frame design of the touch display device.

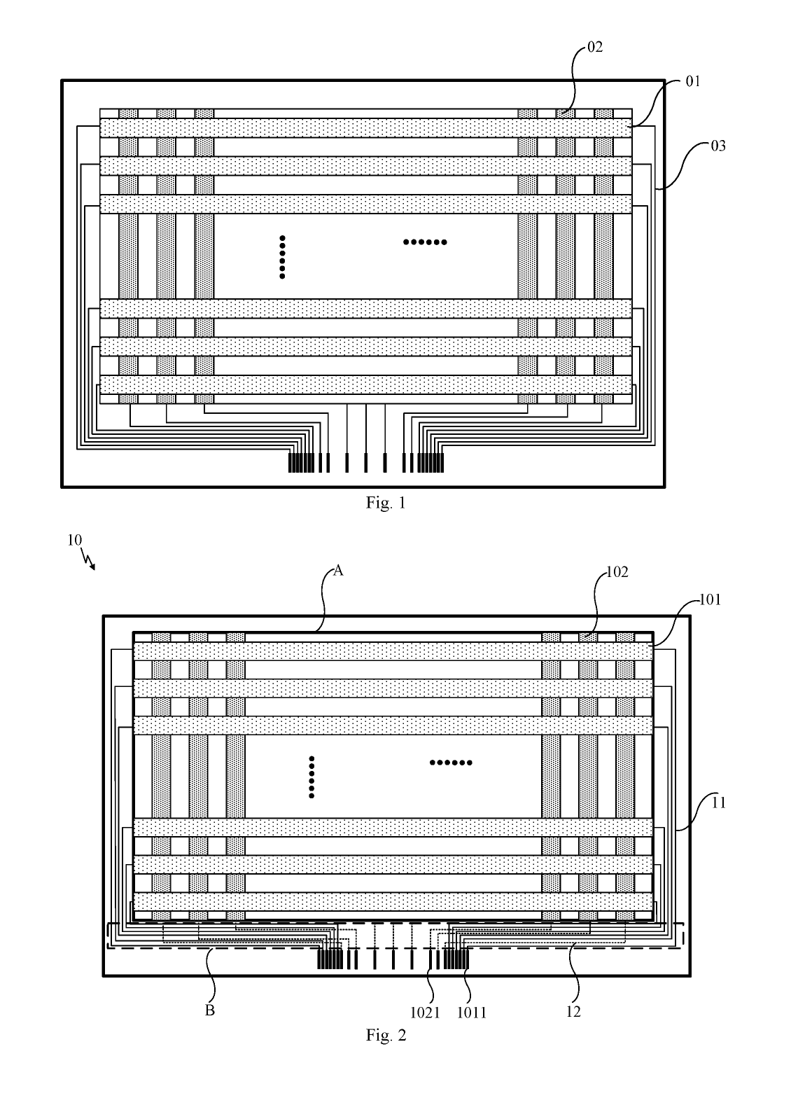

The embodiments of the present disclosure provide a touch substrate. As illustrated in FIG. 2, the touch substrate 10 includes: a plurality of first touch electrodes 101 and a plurality of second touch electrodes 102 provided on a base substrate within a touch region A and being intersected each other laterally and longitudinally; a plurality of first binding patterns 1011 and a plurality of second binding patterns 1021 provided at a side of the touch region A; and first signal lines 11 connecting first touch electrodes 101 to first binding patterns 1011, and second signal lines 12 connecting second touch electrodes 102 to second binding patterns 1021. First signal lines 11 and second signal lines 12 are provided in different layers, and a projection of a region in which first signal lines 11 are located on the base substrate and a projection of a region in which second signal lines 12 are located on the base substrate have partially overlapped regions B. In the present disclosure, as illustrated in FIG. 2, “provided at a side of the touch region A” may refer to the case of being provided at a side portion which is outside the touch region A and immediately adjacent to the touch region A, for example, the lower side as shown in FIG. 2.

Herein, it should be noted that, firstly, as shown in FIG. 2, the plurality of first touch electrodes 101 and the plurality of second touch electrodes 102 intersected each other laterally and longitudinally may refer to the case where the first touch electrodes 101 are lateral touch electrodes and the second touch electrodes 102 are longitudinal touch electrodes, or the case where the first touch electrodes 101 are longitudinal touch electrodes and the second touch electrodes 102 are lateral touch electrodes, which is not limited in the present disclosure. The present disclosure will be further explained below with reference to an example in which the first touch electrodes 101 are lateral touch electrodes and the second touch electrodes 102 are longitudinal touch electrodes.

Secondly, the region in which first signal lines 11 are located may refer to the region surrounded by the outermost first signal line 11 among all the first signal lines 11 as a borderline; and the region in which second signal lines 12 are located may refer to the region surrounded by the outermost second signal line 12 as a borderline.

As the first signal lines and the second signal lines are located in different interlayer structures, the wiring region of the first signal lines and the wiring region of the second signal lines are two independent regions. On this basis, a projection of a region in which first signal lines are located on the base substrate and a projection of a region in which second signal lines are located on the base substrate are partially overlapped. That is, the independent wiring region of the first signal lines and the wiring region of the second signal lines are provided oppositely at at least one side of the touch region in the direction perpendicular to the base substrate. Thereby, the width of the wiring regions provided oppositely equals to merely the width of the wiring region of the first signal lines or the width of the wiring region of the second signal lines. It can significantly reduce the width of the wiring region compared with the comparison example in which the width of the wiring region at this position is the sum of the width of the wiring region of the first signal lines and the width of the wiring region of the second signal lines, which may facilitate the narrow frame design.

The above partially overlapped regions B will be further explained hereinafter.

For example, as illustrated in FIG. 2, the first touch electrodes 101 may be wired at both sides, and the second touch electrodes 102 may be wired at a single side. The partially overlapped regions B are located at the side of the touch region A at which the first binding patterns 1011 and second binding patterns 1021 are provided.

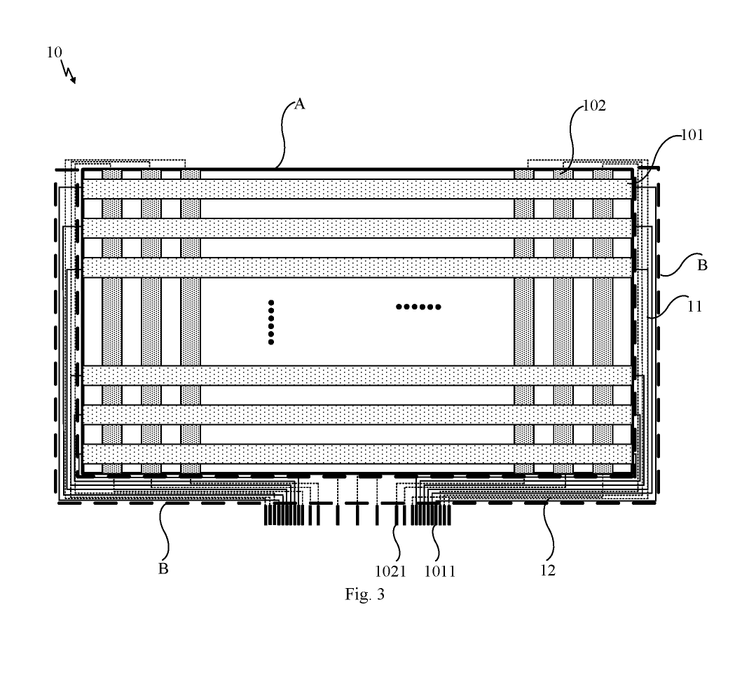

For another example, as illustrated in FIG. 3, both the first touch electrodes 101 and the second touch electrodes 102 may be wired at both sides. The partially overlapped regions B are located at both sides of the touch region A in the direction of first touch electrodes 101 and at the side of the touch region A at which the first binding patterns 1011 and the second binding patterns 1021 are provided.

The specific position of the partially overlapped regions B is not limited in the present disclosure. In actual implementations, the position of the partially overlapped regions B may be determined based on the specific wiring scheme and the specific positions of the first binding patterns 1011 and the second binding patterns 1021.

Different arrangement of the first signal lines 11 and the second signal lines 12 of the first touch electrodes 101 and the second touch electrodes 102 will be explained hereinafter according to specific embodiments.

It should be noted that, “provided in the same layer” herein may refer to the case where different structures are formed by a thin film deposited at the same time, and includes the same components.

As shown in FIG. 4, in the touch substrate 10, the first touch electrodes 101 are formed in an integrated structure, and the second touch electrode 102 includes a row of touch sub electrodes 1020 and bridge point patterns 1022 connecting adjacent ones of the touch sub electrodes 1020. The touch sub electrodes 1020 and the first touch electrodes 101 are provided in the same layer. The bridge point patterns 1022 and the first touch electrodes 101 are provided in different layers.

The specific arrangement of the second signal lines 12 will be explained in detail hereinafter.

For example, the second signal lines 12 and the bridge point patterns 1022 may be provided in the same layer, and the bridge point patterns 1022 and the second signal lines 12 are made of metal. Thus, the bridge point patterns 1022 and the second signal lines 12 are simultaneously formed by a same patterning process, which can simplify the manufacturing process and reduce the manufacturing cost.

For another example, the second signal lines 12 and the bridge point patterns 1022 may be provided in the same layer, and the bridge point patterns 1022 and the second signal lines 12 are made of transparent conductive material. Thus, the bridge point patterns 1022 and the second signal lines 12 are simultaneously formed by a same patterning process, which can simplify the manufacturing process and reduce the manufacturing cost.

With respect to the above description, compared with the case where second signal lines 12 and the bridge point patterns 1022 are formed by a same patterning process and made of transparent conductive material, in the case where the second signal lines 12 and the bridge point patterns 1022 are formed by a same patterning process and made of metal , on one hand, as the resistivity of metal is smaller than that of transparent conductive material, the signal lines made of metal have less influence on the signal applied to the signal lines, while the resistivity of the signal lines made of transparent conductive material is higher, which may affect the signal applied to the signal lines, e.g., cause signal attenuation. Thus, the width of the signal lines made of transparent conductive material is generally greater than that of the signal lines made of metal. The resistance of the signal lines made of transparent conductive material is reduced by increasing the width of such signal lines, so the influence on the signal applied to the signal lines may be reduced, which may in turn cause that the width of wiring regions of signal lines made of transparent conductive material is larger than that of wiring regions of signal lines made of metal. On the other hand, as the light transmittance of transparent conductive material is better than that of metal, compared with bridge point patterns 1022 made of transparent conductive material, bridge point patterns 1022 made of metal may affect the display effect, such as causing reduction of light transmittance. Accordingly, in actual implementation, the second signal lines 12 and bridge point patterns 1022 made of whether metal or transparent conductive material may be selected according to actual needs.

The specific arrangement manner of the first signal lines 11 will be explained hereinafter.

For example, the first signal lines 11 and the first touch electrodes 101 are provided in the same layer. That is, the first signal lines 11 and the first touch electrodes 101 are both made of transparent conductive material and formed by a same patterning process, which simplifies the manufacturing process and reduces the manufacturing cost.

For another example, the first signal lines 11 and the first touch electrodes 101 are provided in different layers. The first signal lines 11 are made of metal which has less influence on the signal applied to the signal lines, and the signal lines made of metal has a narrower width, which facilitates the narrow frame design.

Further, in a case that the first signal lines 11 and the first touch electrodes 101 are provided in different layers, the first signal lines 11 may be connected to the first touch electrodes 101 through a via hole, or the first signal lines 11 and the first touch electrodes 101 may be provided in adjacent layers and connected by directly lapping.

Specifically, in the case that the first signal lines 11 and the first touch electrodes 101 are provided in adjacent layers and lapped to each other, the first signal lines 11 may be formed firstly, then the first touch electrodes 101 are formed, and the first signal lines 11 are directly lapped to the first touch electrodes 101 at an edge position of the touch region A. Alternatively, the first touch electrodes 101 may be formed firstly, then the first signal lines 11 are formed, and the first signal lines 11 are directly lapped to the first touch electrodes 101 at an edge position of the touch region A. Compared with the case that the first signal lines 11 and the first touch electrodes 101 are connected through a via hole, optionally, in the present disclosure, the first signal lines 11 are directly lapped to the first touch electrodes 101 at a connecting position, which can simplify the process and reduce the manufacturing cost. In the present disclosure, the term “lapped” may indicate a position relation in which the first signal lines 11 and the first touch electrodes 101 are physically connected with at least a part thereof overlapped with each other.

In addition, in a case that the second signal lines 12 and the bridge point patterns 1022 made of transparent conductive material are provided in the same layer and the first signal lines 11 made of metal and the first touch electrodes 101 are provided in different layers, as illustrated in FIG. 4, the bridge point patterns 1022, the touch sub electrodes 1020 and first touch electrodes 101 in the touch substrate are all made of transparent conductive material. Optionally, in the present disclosure, compared with the first touch electrodes 101, the bridge point patterns 1022 are closer to the base substrate.

Specifically, in a case that the bridge point patterns 1022 are provided at a side of the first touch electrodes 101 away from the base substrate compared with the touch sub electrodes 1020, that is, in the case that the touch sub electrodes 1020 and the first touch electrodes 101 are formed firstly, and then the bridge point patterns 1022 are formed, as the area of the bridge point patterns 1022 is smaller than that of patterns of the first touch electrodes 101 and the touch sub electrodes 1020, it is necessary to etch a large area of transparent conductive film to form the bridge point patterns 1022. Thus, in the etching process, it is difficult to accurately control etching degree, which may cause undesired etching of the touch sub electrodes 1020 and the first touch electrodes 101.

However, in a case that the bridge point patterns 1022 are provided at a side of the first touch electrodes 101 close to the base substrate compared with the touch sub electrodes 1020, the bridge point patterns 1022 which has a smaller area are formed firstly. In the process of forming the touch sub electrodes 1020 and the first touch electrodes 101, with the protection of an insulating pattern between bridge point patterns 1022 and touch sub electrodes 1020 and with the shielding of the touch sub electrodes 1020, the etching process will not damage the bridge point patterns 1022. Therefore, optionally, compared with the first touch electrodes 101, the bridge point patterns 1022 are closer to the base substrate.

As illustrated in FIG. 2 or FIG. 3, the first touch electrodes 101 and the second touch electrodes 102 are both formed in integrated structures, respectively.

In this case, the first signal lines 11 and the first touch electrodes 101 are provided in the same layer. That is, the first signal lines 11 and the first touch electrodes 101 are both made of transparent conductive material, the second signal lines 12 and the second touch electrodes 102 are provided in different layers, the second signal lines 12 are made of metal. Alternatively, the second signal lines 12 and the second touch electrodes 101 are provided in the same layer. That is, the second signal lines 12 and the second touch electrodes 101 are both made of transparent conductive material, the first signal lines 11 and the first touch electrodes 101 are provided in different layers, and the first signal lines 11 are made of metal.

The signal lines provided in the same layer with the touch electrodes are formed by one patterning process simultaneously with forming the touch electrodes, which can simplify the process and reduce the manufacturing cost. Meanwhile, by providing the metal signal lines provided in different layers from the touch electrodes, the metal signal lines have good electrical conductivity and will not affect the signal. Compared with the comparison example, narrow frame design can be achieved without increasing manufacturing processes.

In summary, in the present embodiments, in a case that one of the first signal line 11 and the second signal line 12 is made of metal and the other is made of transparent conductive material, optionally, the signal lines made of metal are further away from the base substrate compared with the signal lines made of transparent conductive material. Thereby, the first binding patterns 1011 and the second binding patterns 1021 may be formed by a same patterning process while forming the metal signal lines, which can simplify the manufacturing process and reduce the manufacturing cost.

Specifically, in a case that the second signal lines 12 are made of metal and the first signal lines 11 are made of transparent conductive material, the second signal lines 12 may be provided at a side further away from the base substrate compared with the first signal lines 11. Thereby, the first binding patterns 1011 and the second binding patterns 1021 may be formed by a same patterning process while forming the second signal lines 12. In the embodiment, the second binding patterns 1021 are directly connected to the second signal lines 12, and the first binding patterns 1011 are connected to the first signal lines 11 therebelow through a via hole.

Alternatively, in a case that the first signal lines 11 are made of metal and the second signal lines 12 are made of transparent conductive material, the first signal lines 11 may be provided at a side further away from the base substrate compared with the second signal lines 12. Thereby, the first binding patterns 1011 and the second binding patterns 1021 may be formed by a same patterning process while forming the first signal lines 11. In the embodiment, the first binding patterns 1011 are directly connected to the first signal lines 11, and the second binding patterns 1021 are connected to the second signal lines 12 therebelow through a via hole.

In addition, with respect to the arrangement manner of the first touch electrodes 101 and the second touch electrodes 102 in the present embodiments, in the embodiment in which the first touch electrodes 101 and the touch sub electrodes 1020 of the second touch electrodes 102 are provided in the same layer and the bridge point patterns 1022 are separately provided in another layer, it is only required to provide a transparent insulating pattern at the position corresponding to the bridge point patterns 1022, such that the first touch electrodes 101 and the second touch electrodes 102 are insulated from each other at the bridge connecting position. However, in the embodiment in which the first touch electrodes 101 and the second touch electrodes 102 are separate structures, the whole layer of transparent insulating layer is provided at the first touch electrodes 101 and the second touch electrodes 102. As the transparent insulating material can appropriately reduce the light transmission, the light transmittance in the previous embodiment is better than that in the present embodiment. Thereby, in an optional embodiment of the present disclosure, the first touch electrodes 101 and the touch sub electrodes 1020 of the second touch electrodes 102 are provided in the same layer and the bridge point patterns 1022 are separately provided in another layer.

The embodiments of the present disclosure further provide a touch device including the touch substrate above and having the same structures and advantages as those of the touch substrate provided in the previous embodiments. Since the structure and advantages of the touch substrate have been described in detail in the previous embodiments, details will not be repeated hereinafter.

It should be noted that, in the embodiments of the present disclosure, the display device may specifically include at least a liquid crystal display panel and an organic light emitting diode display panel. For example, the display panel may be applied to any product or component having a display function, such as a liquid crystal display, a liquid crystal television, a digital photo frame, a mobile phone, a tablet, and the like.

On this basis, in a case that the above touch device includes the display panel 20, the specific arrangement of the touch substrate 10 in the touch device will be further explained below.

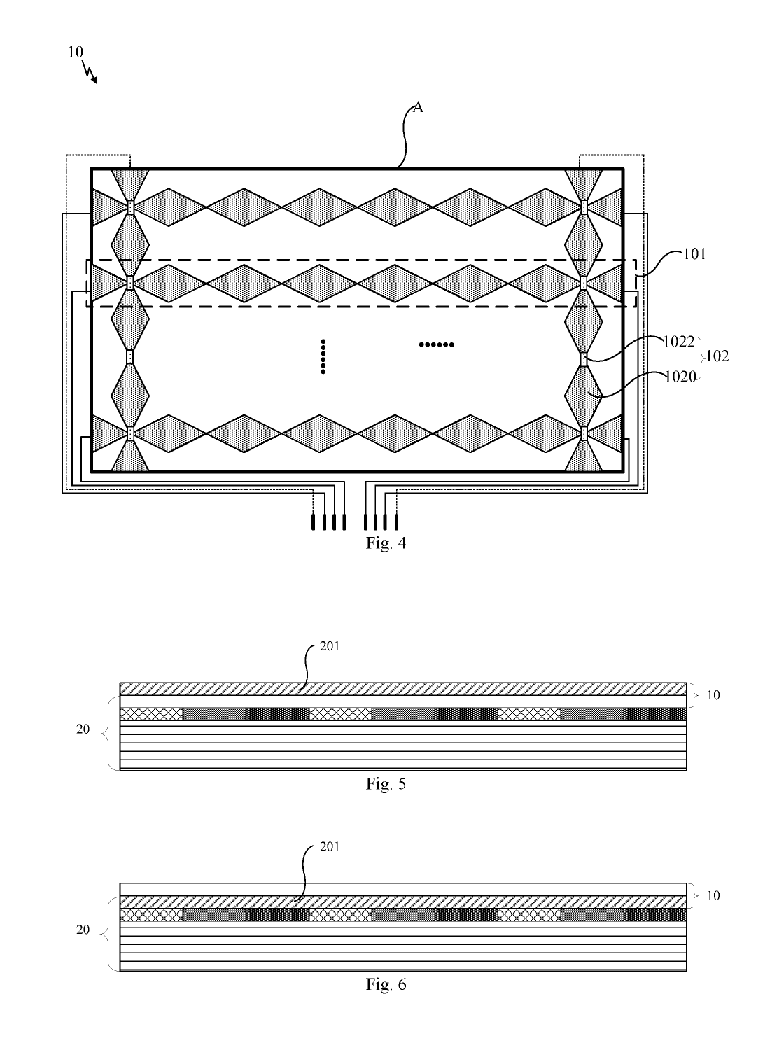

For example, as illustrated in FIG. 5, the touch substrate 10 may be integrated with the display panel 20, and the touch substrate 10 is located inside the display panel 20. The display panel 20 and the touch substrate 10 share the same base substrate 201.

For another example, as illustrated in FIG. 6, the touch substrate 10 may be integrated with the display panel 20, and the touch substrate 10 is located outside the display panel 20. The display panel 20 and the touch substrate 10 share the same base substrate 201.

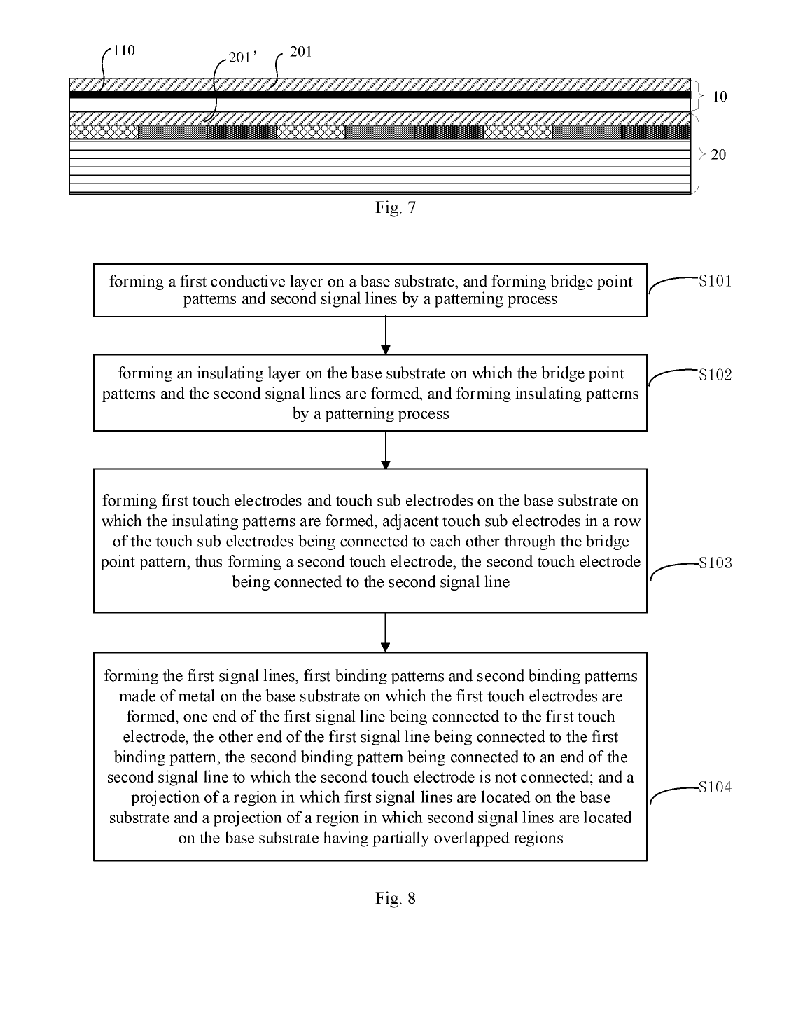

For still another example, as illustrated in FIG. 7, the touch substrate 10 and the display panel 20 are two separate structures. That is, the touch substrate 10 and the display panel 20 are formed on two different base substrates 201 and 201′, and the touch substrate 10 is located outside the display panel 20.

It should be noted that, in the display device shown in FIG. 7, the touch substrate 10 and the display panel 20 are separate structures, i.e., it is an out-cell touch substrate. As illustrated in FIG. 7, in a manufacturing process of the touch substrate 10, a light shielding layer 110 may be provided at a side of corresponding wiring region close to the base substrate 201. The material of the light shielding layer may be black matrix material, so as to prevent external light from directly irradiating on the wiring region and producing reflection, thereby preventing an adverse effect on display effect of the display device.

In addition, in the display devices shown in FIGS. 5 and 6, the touch substrate 10 and the display panel 20 are an integrated structure, i.e., an on-cell touch substrate. A light shielding layer (not illustrated in the figures) is provided at a corresponding wiring region on a packaging substrate or a packaging film outside the touch substrate 10 and the display panel 20 of the integrated structure, so as to prevent external light from directly irradiating on the wiring region, thereby preventing an adverse effect on display effect.

The embodiments of the present disclosure further provide a manufacturing method of a touch substrate, as illustrated in FIG. 8, which include following steps.

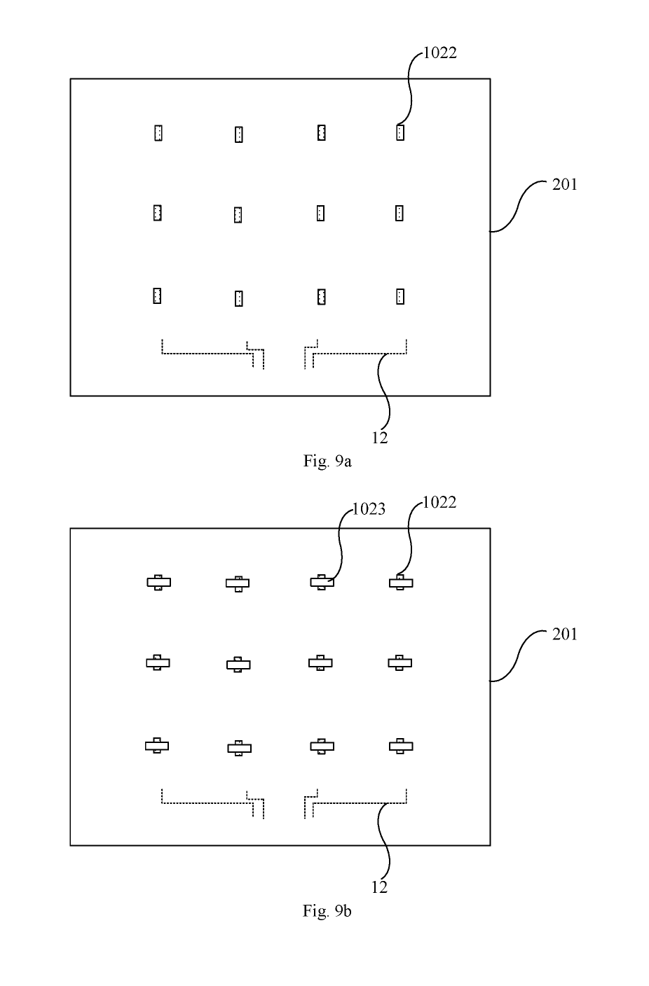

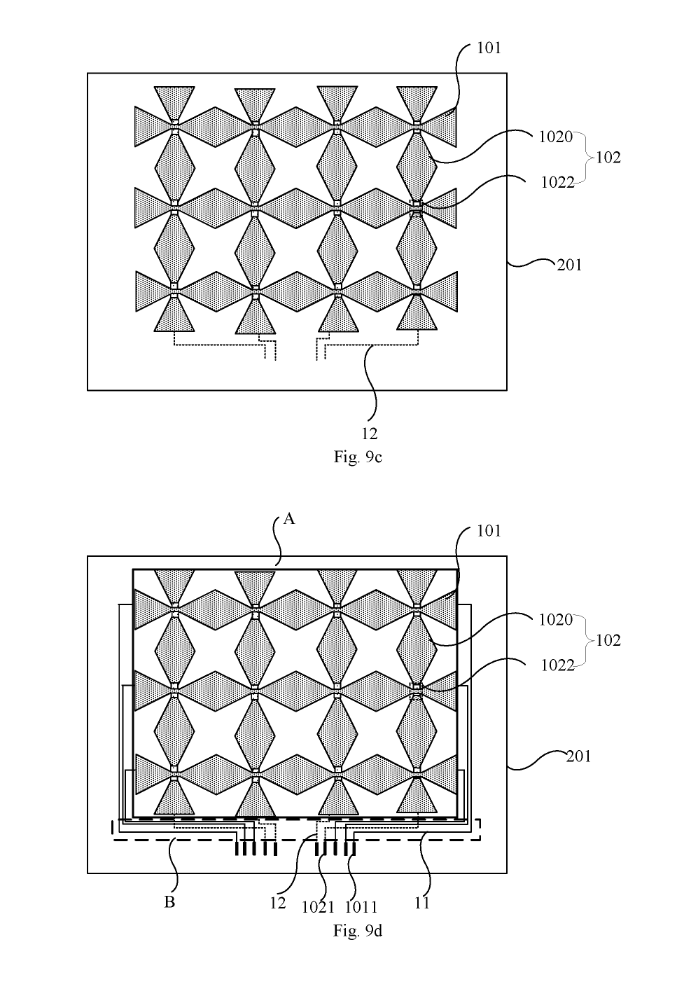

Step S101, as shown in FIG. 9a, a first conductive layer is formed on a base substrate 201, and bridge point patterns 1022 and second signal lines 12 are formed by a patterning process.

Herein, the first conductive layer may be made of metal or transparent conductive material.

Step S102, as shown in FIG. 9b, an insulating layer is formed on the base substrate 201 on which the bridge point patterns 1022 and the second signal lines 12 are formed, and insulating patterns 1023 are formed by a patterning process.

Specifically, the above insulating patterns 1023 include insulating patterns located at positions corresponding to the bridge point patterns 1022 and insulating patterns (not illustrated in the figures) at a region of the second signal lines 12.

Step S103, as shown in FIG. 9c, first touch electrodes 101 and touch sub electrodes 1020 are formed on the base substrate 201 on which the insulating patterns 1023 are formed. In the embodiment, adjacent touch sub electrodes 1020 in a row of the touch sub electrodes 1020 are connected to each other through the bridge point pattern 1022, thus forming a second touch electrode 102. The second touch electrode 102 is connected to the second signal line 12.

Step S104, as shown in FIG. 9d, first signal lines 11, first binding patterns 1011 and second binding patterns 1021 made of metal are formed on the base substrate 201 on which the first touch electrodes 101 are formed. In the embodiment, one end of the first signal line 11 is connected to the first touch electrode 101, the other end of the first signal line 11 is connected to the first binding pattern 1011, and the second binding pattern 1021 is connected to an end of the second signal line 12 to which the second touch electrode 102 is not connected. A projection of a region in which first signal lines 11 are located on the base substrate 201 and a projection of a region in which second signal lines 12 are located on the base substrate 201 have partially overlapped regions B.

Specifically, as shown in FIG. 9d, the above partially overlapped regions B may be located at a side of a touch region A at which the first binding patterns 1011 and the second binding patterns 1021 are provided.

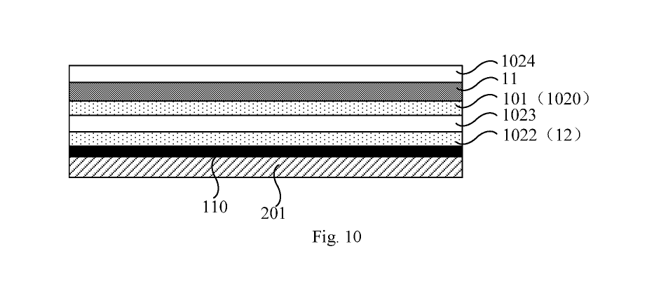

Here, it should be noted that, in a case that the touch substrate 10 is the out-cell touch substrate shown in FIG. 7, as illustrated in FIG. 10, before the step S101, a light shielding layer 110 made of black matrix material may be formed on a wiring region on which the first signal lines 11 and the second signal lines 12 are pre-formed, such that when the touch substrate 10 is applied to the display device, it can prevent external light from directly irradiating on the wiring region, thereby preventing an adverse effect on display effect. In the embodiment, FIG. 10 illustrates only the order for forming the layers of each structure, and does not represent an actual cross-sectional view of a certain position of the touch substrate 10.

In addition, after the step S104, as illustrated in FIG. 10, a protective layer 1024 may also be formed, so as to prevent external factors from affecting the interior of the touch substrate 10, such as air oxidation, acid-base corrosion and the like, which can protect the touch substrate 10.

The embodiments of the present disclosure provide a touch substrate, a manufacturing method thereof and a touch device. The touch substrate includes: a plurality of first touch electrodes and a plurality of second touch electrodes provided on a base substrate within a touch region and being intersected each other laterally and longitudinally; a plurality of first binding patterns and a plurality of second binding patterns provided at a side of the touch region; and first signal lines connecting first touch electrodes to first binding patterns, and second signal lines connecting second touch electrodes to second binding patterns. The first signal lines and the second signal lines are provided in different layers. As the first signal lines and the second signal lines are located in different interlayer structures, the wiring region of the first signal lines and the wiring region of the second signal lines are two independent regions. On this basis, a projection of a region in which first signal lines are located on the base substrate and a projection of a region in which second signal lines are located on the base substrate are partially overlapped. That is, the independent wiring region of the first signal lines and the wiring region of the second signal lines are provided oppositely at at least one side of the touch region in the direction perpendicular to the base substrate. Thereby, the width of the wiring regions provided oppositely equals to merely the width of the wiring region of the first signal lines or the width of the wiring region of the second signal lines. It can significantly reduce the width of the wiring region compared with the comparison example in which the width of the wiring region at this position is the sum of the width of the wiring region of the first signal lines and the width of the wiring region of the second signal lines, which may facilitate the narrow frame design.

The foregoing descriptions are merely specific embodiments of the present disclosure, but the protection scope of the present disclosure is not limited thereto. Changes or substitutions easily conceived by anyone skilled in the art within the technical scope disclosed in the present disclosure should be covered in the protection scope of the present disclosure. Therefore, the protection scope of the present disclosure should be based on the protection scope of the claims.

1. A touch substrate, comprising:
a plurality of first touch electrodes and a plurality of second touch electrodes, provided on a base substrate within a touch region and intersected each other laterally and longitudinally;
a plurality of first binding patterns and a plurality of second binding patterns, provided at a side of the touch region;
first signal lines, connecting the first touch electrodes to the first binding patterns, and
second signal lines, connecting the second touch electrodes to the second binding patterns, wherein, the first signal lines and the second signal lines are provided in different layers, and a projection of a region in which the first signal lines are located on the base substrate and a projection of a region in which the second signal lines are located on the base substrate have partially overlapped regions.

2. The touch substrate according to claim 1, wherein the partially overlapped regions are located at a side of the touch region at which the first binding patterns and the second binding patterns are provided.

3. The touch substrate according to claim 1, wherein the first touch electrodes are formed in an integrated structure, the second touch electrodes comprise a row of touch sub electrodes and bridge point patterns connecting adjacent ones of the touch sub electrodes, the touch sub electrodes and the first touch electrodes are provided in a same layer, and the bridge point patterns and the first touch electrodes are provided in different layers.

4. The touch substrate according to claim 3, wherein the second signal lines and the bridge point patterns are provided in a same layer, and the bridge point patterns and the second signal lines are made of metal or transparent conductive material.

5. The touch substrate according to claim 3, wherein the first signal lines and the first touch electrodes are provided in a same layer, and wherein the first signal lines are made of metal.

6. The touch substrate according to claim 5, wherein the first signal lines are lapped to the first touch electrodes at a connecting position.

7. The touch substrate according to claim 3, wherein in a case that the second signal lines and the bridge point patterns are provided in a same layer, the bridge point patterns are made of transparent conductive material, the first signal lines and the first touch electrodes are provided in different layers, and the first signal lines are made of metal, a distance between the bridge point patterns and the base substrate is smaller than a distance between the first touch electrodes and the base substrate.

8. The touch substrate according to claim 1, wherein the first touch electrodes and the second touch electrodes are formed in integrated structures, respectively;
the first signal lines and the first touch electrodes are provided in a same layer, the second signal lines and the second touch electrodes are provided in different layers, and the second signal lines are made of metal.

9. The touch substrate according to claim 1, wherein in a case that the second signal lines are made of metal and the first signal lines are made of transparent conductive material, a distance between the second signal lines and the base substrate is greater than a distance between the first signal lines and the base substrate.

10. The touch substrate according to claim 1, wherein the first signal lines are made of metal, the second signal lines are made of transparent conductive material, and a distance between the first signal lines and the base substrate is greater than a distance between the second signal lines and the base substrate.

11. A touch device, comprising the touch substrate according to claim 1.

12. The touch device according to claim 11, wherein the touch device comprises a display panel, the touch substrate and the display panel are formed in an integrated structure, the touch substrate is located inside or outside the display panel, and the display panel and the touch substrate share a same base substrate.

13. A manufacturing method of a touch substrate, comprising:
forming a first conductive layer on a base substrate, and forming bridge point patterns and second signal lines by a patterning process;
forming an insulating layer on the base substrate on which the bridge point patterns and the second signal lines are provided, and forming insulating patterns by a patterning process;
forming first touch electrodes and touch sub electrodes on the base substrate on which the insulating patterns are formed, wherein, the adjacent touch sub electrodes in a row of the touch sub electrodes are connected to each other through the bridge point pattern, and form a second touch electrode, and the second touch electrode is connected to the second signal line;
forming first signal lines, first binding patterns and second binding patterns made of metal on the base substrate on which the first touch electrodes are formed, wherein, one end of the first signal line is connected to the first touch electrode, the other end of the first signal line is connected to the first binding pattern, the second binding pattern is connected to an end of the second signal line to which the second touch electrode is not connected, and a projection of a region in which first signal lines are located on the base substrate and a projection of a region in which second signal lines are located on the base substrate have partially overlapped regions.

14. The touch substrate according to claim 3, wherein the first signal lines and the first touch electrodes are provided in different layers, and wherein the first signal lines are made of metal.

15. The touch substrate according to claim 14, wherein the first signal lines are lapped to the first touch electrodes at a connecting position.

16. The touch substrate according to claim 1, wherein the first touch electrodes and the second touch electrodes are formed in integrated structures, respectively; the second signal lines and the second touch electrodes are provided in a same layer, the first signal lines and the first touch electrodes are provided in different layers, and the first signal lines are made of metal.

17. The touch device according to claim 11, wherein the touch device comprises a display panel, the touch substrate and the display panel are two separate structures, and the touch substrate is located outside the display panel.
